(19) United States
(12) Patent Application Publication
(10) Pub. No.: US 2026/0063358 A1
(43) Pub. Date: Mar. 5, 2026

(54) FOOD PREPARATION AND OVERNIGHT STORAGE SYSTEM AND METHOD

(71) Applicant: ELECTROLUX PROFESSIONAL, INC., VICKSBURG, MS (US)

(72) Inventors: RYAN MCMARTIN, MOUNT PLEASANT, MI (US); BRIAN SIMON, WEIDMAN, MI (US); ORINDO DELORENZO, MOUNT PLEASANT, MI (US)

(21) Appl. No.: 19/313,299

(22) Filed: Aug. 28, 2025

Related U.S. Application Data
(60) Provisional application No. 63/688,751, filed on Aug. 29, 2024.

(51) Int. Cl. F25D 29/00; A47J 39/02; A47J 47/02

(52) U.S. Cl. CPC F25D 29/00; A47J 39/02; A47J 39/025; A47J 47/02; A47J 2202/00

(57) ABSTRACT

A food preparation system and method are provided. The food preparation system includes an upper, food preparation station and a lower, base unit. The food preparation station includes a preparation surface and a food storage section. The food storage section defines a cavity and mounts a rail configured to mount food storage compartments configured to house food ingredients. The base unit may comprise a base cabinet. The food preparation system further comprises a cooling system and an integrated food storage area open/close sensor system, switch, and controller for switching between open and closed temperature settings. The food preparation system and method accommodate extended storage of food items, including overnight storage, in addition to use for preparation of food items.

### CROSS-REFERENCE TO RELATED APPLICATIONS

This application claims priority pursuant to 35 U.S.C. § 119(e) to co-pending U.S. Provisional Patent Application Ser. No. 63/688,751, filed Aug. 29, 2024, the entire disclosure of which is incorporated herein by reference.

### FIELD OF THE INVENTION

The present invention relates generally to food preparation and storage. More specifically, the present invention is concerned with a food preparation system having overnight storage features and methods of use thereof.

### BACKGROUND OF THE INVENTION

Food preparation stations are utilized in many restaurants and other commercial kitchens during one or more steps in the food preparation and service process. Such preparation stations, sometimes referred to as prep stations or prep tables, serve as a primary location where food items are prepared, stored, and/or assembled into final food products. Oftentimes, preparation stations are customizable or configurable for use in particular commercial environments. For example, some preparation stations are modifiable such that different hardware can selectively be installed within or in association with various components, cabinets, and features of the preparation station. Depending upon the particular use case, these components, cabinets, and features of the preparation stations are arranged or ordered in specific combinations such that they facilitate the proper workflow necessary for the particular commercial kitchen environment.

Maintaining proper food temperatures is critical in the food service and food sales industries. Failure to maintain proper food temperatures can cause food safety issues, reduce food quality, increase waste, and/or lead to failed inspections. Ordinarily, food temperatures can be maintained with a relatively high degree of confidence simply by storing the food in an area having a relatively constant temperature. For instance, frozen food generally remains frozen when it is stored in a freezer, chilled food generally remains chilled when it is stored in a cooler, and hot food generally remains hot when it is kept in a warmer. Food temperatures are more difficult to maintain, however, when the surrounding environment is maintained at a temperature that is different from the required temperature for the food.

The surrounding environment for a food preparation station is typically maintained at ambient room temperature despite the requirement to maintain many of the food items contained within the food preparation station at lower or higher temperatures. Moreover, it has become very popular to transition food preparation areas from a back kitchen to the front of a restaurant for customers to see, particularly in “fast casual” restaurants. Many such front of store food preparation areas allow customers to glance through a transparent partition at a variety of ingredients and/or toppings, such as cheeses, meats, fruits, vegetables, and the like, thereby providing customers with a variety of choices. This model has become so prevalent that customers often expect to be able to view and choose from many ingredient or topping choices at certain restaurants. Nevertheless, these same customers also continue to expect fast service. Consequently, ingredient and topping contents housed within many food preparation systems are rarely covered (often containers have no lids or container lids are left off for long periods of time for convenience and/or by mistake), leaving them exposed to ambient temperature air for long periods of time, increasing the chances that the temperature of one or more ingredient or topping will become unsafe. The higher the ambient temperature, the greater the risk.

Although front of store food preparation areas have grown in popularity, food preparation stations also continue to be very commonly used within back kitchens or other commercial kitchens. Similar to front of store uses, food preparation stations within commercial kitchens are typically used to prepare, store, and mix together ingredients frequently used in the food preparation and service process. Commercial kitchens are usually fast-paced environments, so having ingredients prepped and ready to use in an easy to access container can greatly increase speed and efficiency in getting a finished food product from the kitchen to a consumer. Nevertheless, such food preparation setups often result in ingredients remaining open and exposed to ambient air.

Moreover, as a quantity of food items within a bin is depleted, operators will either refill or replace the bin. In either case, food products that have been exposed to ambient air for some time are typically mixed with new food products, thereby increasing the amount of time before the original food is served and decreasing the amount of time before the new food will spoil or become unsafe. In some circumstances, a new bin is stored in a chiller or a warmer, as the case may be, prior to being moved to the food preparation station. In some such circumstances, the food within the bin has already warmed (or cooled as the case may be) to a temperature outside of a desired range due to a malfunction in one or more system, a lid being left off for too long, an operator simply mishandling the food item (such as leaving the food item out for too long prior to moving it to a cooler, to a warmer, and/or to the food prep area), and/or any number of other reasons. In some such circumstances, such food item(s) are at a much higher risk of reaching an unsafe and/or undesirable temperature prior to being served and/or may reach an unsafe and/or undesirable temperature prior to even being moved to a food prep area.

Additionally, ensuring consistency in food preparation is vital in maintaining a high level of quality control and inventory management within the food industry. For instance, a consumer visiting a restaurant and ordering a particular food item expects that food item to be the same from visit to visit and the same at varying locations of the restaurant the customer visits. Oftentimes, inconsistencies with food preparation can lead to lower customer satisfaction and lower revisiting patronage of single location restaurants and large chain restaurants alike. Additionally, inconsistent preparation of food items greatly impacts the predictability of inventory flow. For restaurants serving hundreds or thousands of orders daily, small variances can lead to lost profits due to lost sales from lack of stocked product or from having to throw out product which goes unused due to over-stocking.

To account for such issues, some food preparation systems include an integrated cooling system or are configured to attach to a cooling system for cooling food items within the food preparation systems. Nevertheless, the amount of cooling required to keep food items within a desired temperature range when containers housing the food items are open to ambient air is significantly higher than if such food items were fully enclosed. Thus, in previous food preparation systems which include a cooling system, if an enclosure is closed over the food items (i.e., no longer exposing to food items to ambient air) with the cooling system running and maintained at the same cooling level, the food items therein are likely to freeze. Accordingly, when using current food preparation systems, the food items housed within must be removed at the end of the food service process in order to keep such food items fresh. While food preparation stations often improve efficiency in preparing and serving food items to consumers, breaking down a food preparation station at the end of a shift can be tedious and/or wasteful of prepared ingredients. Some food preparation systems include cooling systems associated with the preparation system.

Accordingly, it would be beneficial to have a food preparation system configured to safely regulate temperature to help prevent spoliation and unwanted freezing of food items therein. Furthermore, it would be beneficial to have a food preparation system configured to change temperature settings to allow for safe overnight storage.

Heretofore there has not been available a system or method for food preparation and storage with the advantages and features of the present invention.

### SUMMARY OF THE INVENTION

The present invention comprises a food preparation system and method. In an exemplary embodiment, the food preparation system of the present invention accommodates overnight storage of food items with incorporation of a cooling system and an integrated open/close sensor system, switch, and controller for toggling between open and closed temperature settings.

In an exemplary embodiment of the present invention, a food preparation system includes a base unit and further defines a top food housing cavity, or rail, configured to receive and house various food items for use in the food preparation and service process. In an exemplary embodiment, the top food housing cavity further includes an integrated access and enclosure lid which is capable of being selectively opened and closed by a user of the system.

In an exemplary embodiment, a base unit of the food preparation system includes a base cabinet. In embodiments, a base cabinet of the present invention includes one or more drawers. In embodiments, drawers of a base cabinet provide additional storage for food items and/or food preparation and service accessories such as utensils, cookware, dishware, food packaging materials, etc. In some embodiments, drawers of the base cabinet further comprise food warmer, freezer, and/or cooler drawer(s). In embodiments, a base cabinet of the present invention further comprises a housing for a cooling system configured to cool the contents of the food housing cavity to assist with maintaining safe food temperatures.

In an exemplary embodiment of the present invention, the cooling system comprises a wrapped wall cooling system for the food housing cavity. In an exemplary embodiment, one or more drawers or compartments of the base cabinet of the food preparation system also includes wrapped wall cooling. In additional embodiments, a cooling system of the present invention includes a compressor, one or more utility lines, and a fan unit.

In an exemplary embodiment of the present invention, the cooling system is electrically connected to a controller and system processor configured to control parameters of the cooling system. In an exemplary embodiment, the system processor is configured with a first setting of the cooling system for when the food housing cavity is in an open configuration and a second setting of the cooling system for when the food housing cavity is in a closed configuration. In embodiments, the food preparation system further comprises one or more sensors configured to detect whether the food housing cavity is open or closed and/or one or more temperature sensors. In an exemplary embodiment, such cavity open/close sensor(s) and/or temperature sensor(s) are electrically connected to a switch which is electrically connected to the controller for switching between the first, open setting and the second, closed setting of the cooling system when the food housing cavity is open or closed. In exemplary embodiments, one or more electrical wire is connected to a sensor and routed through the food preparation system to a controller box housed within the food preparation system.

In further embodiments, the food preparation system includes a user-operated switch configured to allow a user to manually switch between the first and second settings of the cooling system. In some embodiments including both a manual switch and open/close sensor(s) and/or temperature sensor(s), the system includes a manual override option for setting the temperature of the cooling system.

In embodiments, the first and/or second setting of the cooling system is capable of being adjusted as needed to account for the ambient air temperature. In further embodiments, the cooling system is configured with any number of additional temperature settings as desired for different sections or compartments of the food housing cavity.

In embodiments, the present food preparation system of the present invention further includes a work surface or table adjacent to or otherwise positioned near the food housing cavity.

The present food preparation system accommodates efficient preparation, storage, and usage of food item ingredients at safe temperatures. The present invention further allows for longer storage of food items, including overnight storage, at safe temperatures without unwanted freezing of food items by incorporating sensors, a switch, and a controller for switching cooling system settings between an open food housing cavity setpoint and a closed food housing cavity setpoint. Such systems help cutdown on break down time and/or food waste by allowing food service providers to hold prepped ingredients safely for the next day without having to move the ingredients into another cooler or freezer.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

FIG. 1 shows an upper, front, perspective view of a food preparation system of the present invention with a top enclosure in a closed configuration and an enlarged, top, front, perspective view of a magnet cap configured to house a magnet for magnetic closure of the top enclosure.

FIG. 2 shows a back, side, perspective view of the food preparation system with an end wall and a portion of a back wall removed to illustrate a cooling system of the present system. FIG. 2 further shows an enlarged, back, side, perspective view of electronic connections between a sensor switch and control unit of the food preparation system.

FIG. 3 shows an end, elevational, cross-sectional view of the food preparation system, illustrating the cooling system of the present invention, and an enlarged, elevational view of a magnetic closure interaction of the top enclosure door.

FIG. 4 shows end, elevational, cross-sectional views of a top enclosure door magnetic closure apparatus and associated switch of the food preparation system.

FIG. 5 shows end, elevational, cross-sectional views of the food preparation system illustrating a magnetic open/close sensor wire routed to a controller of the system.

FIG. 6 shows additional elevational, cross-sectional views of the food preparation system.

FIG. 7 shows an upper, front, perspective view of an alternative embodiment of a food preparation system of the present invention.

FIG. 8 shows a front, elevational view of the alternative food preparation system.

FIG. 9 shows a back, elevational view of the alternative food preparation system.

FIG. 10 shows a right end, elevational view of the alternative food preparation system.

FIG. 11 shows a left end, elevational view of the alternative food preparation system.

FIG. 12 shows a top, plan view of the alternative food preparation system.

FIG. 13 shows a bottom, plan view of the alternative food preparation system.

The drawing figures do not limit the present invention to the specific embodiments disclosed and described herein. The drawings are not necessarily to scale, emphasis instead being placed upon illustrating the principles of the invention.

### DETAILED DESCRIPTION OF THE PREFERRED EMBODIMENTS

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention comprises a food preparation system 10 and method. In an exemplary embodiment, the food preparation system 10 includes an upper, food preparation station 100 and a lower, base unit 200. In an exemplary embodiment, the food preparation station 100 includes one or more preparation surfaces 110 and one or more food storage areas 120. In an exemplary embodiment, the base unit 200 comprises a base cabinet 210. In an exemplary embodiment, the present food preparation system 10 further comprises a cooling system 220 and an integrated food storage area open/close sensor system, switch, and controller for toggling between open and closed temperature settings. In an exemplary embodiment, the food preparation system 10 of the present invention accommodates overnight storage of food items in addition to use for preparation of food items.

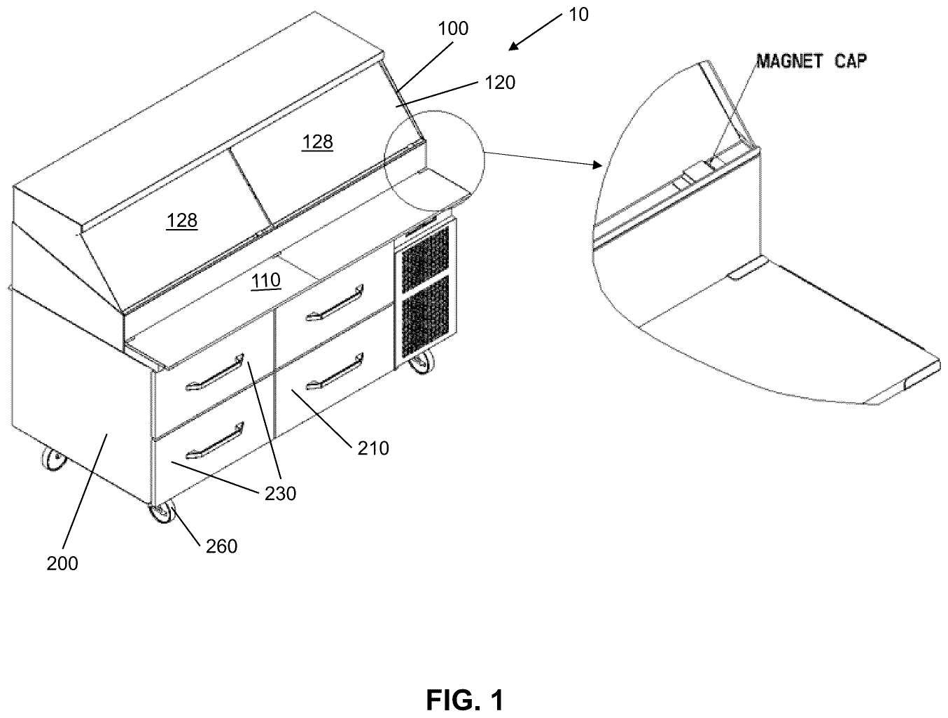

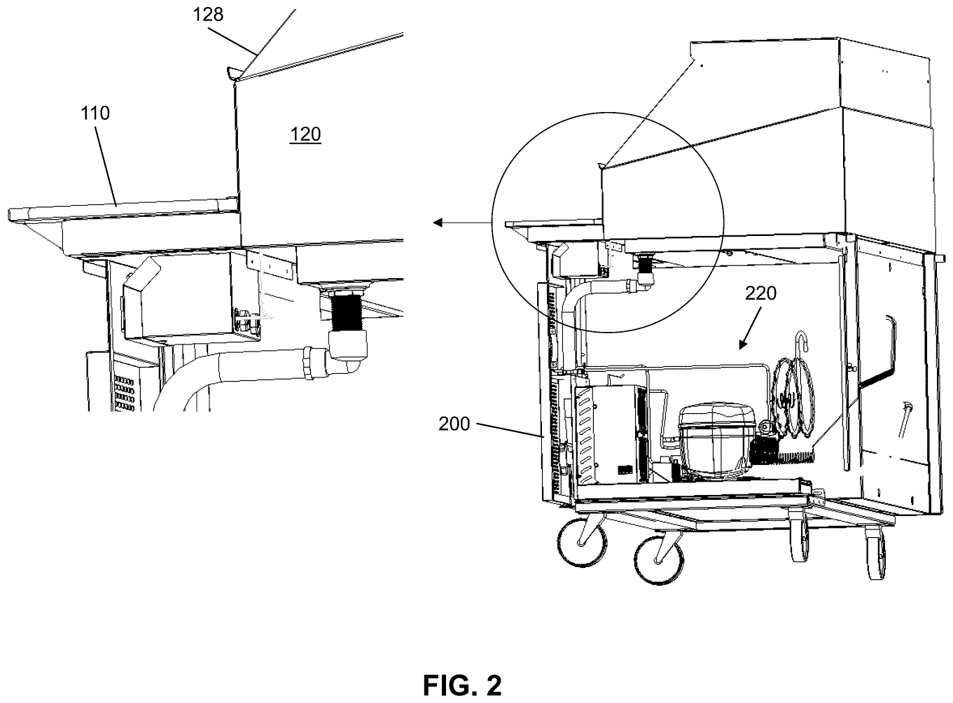

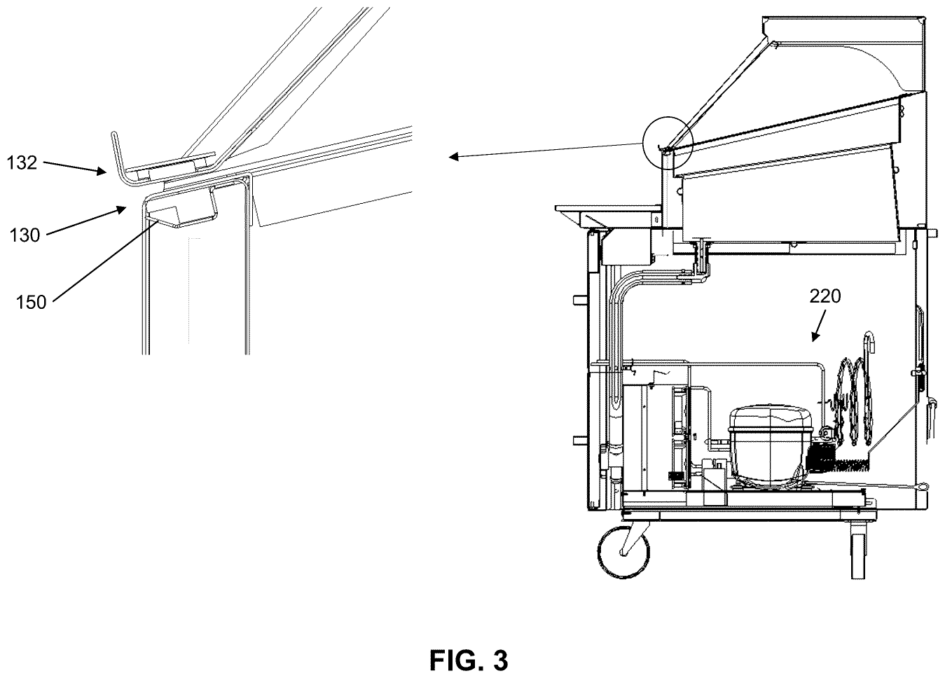

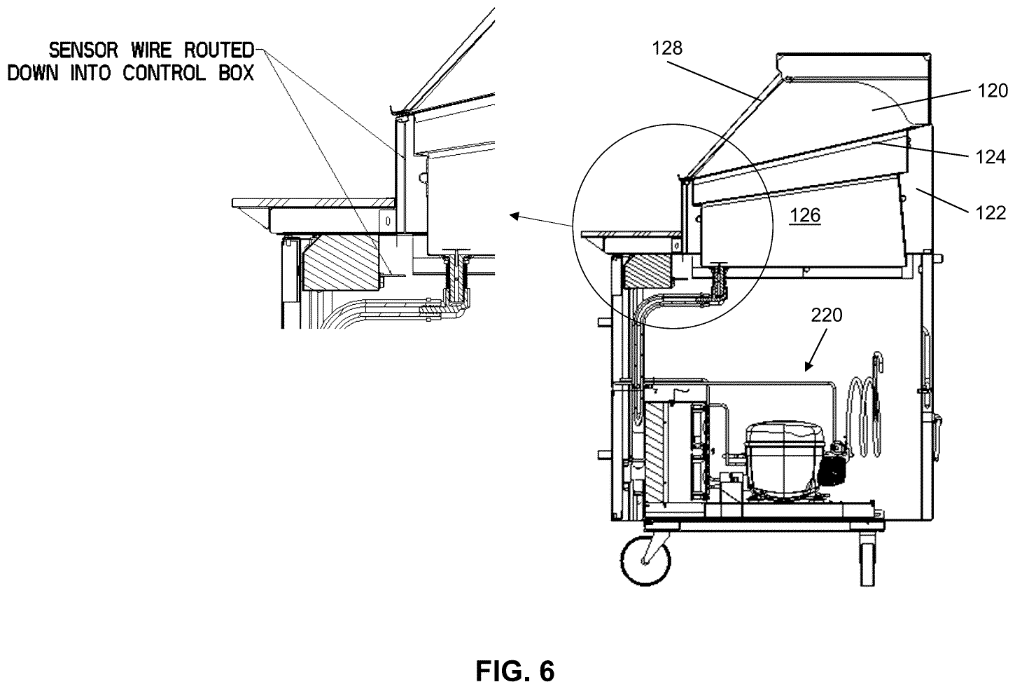

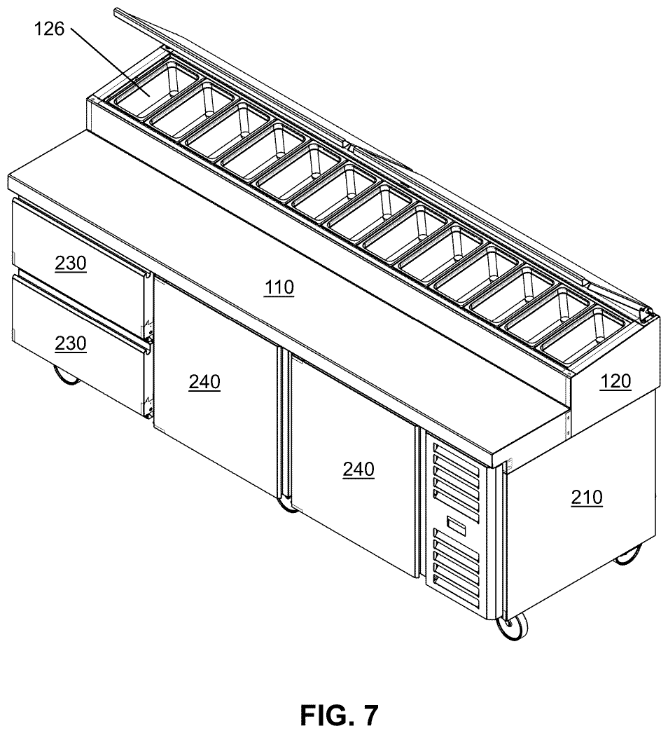

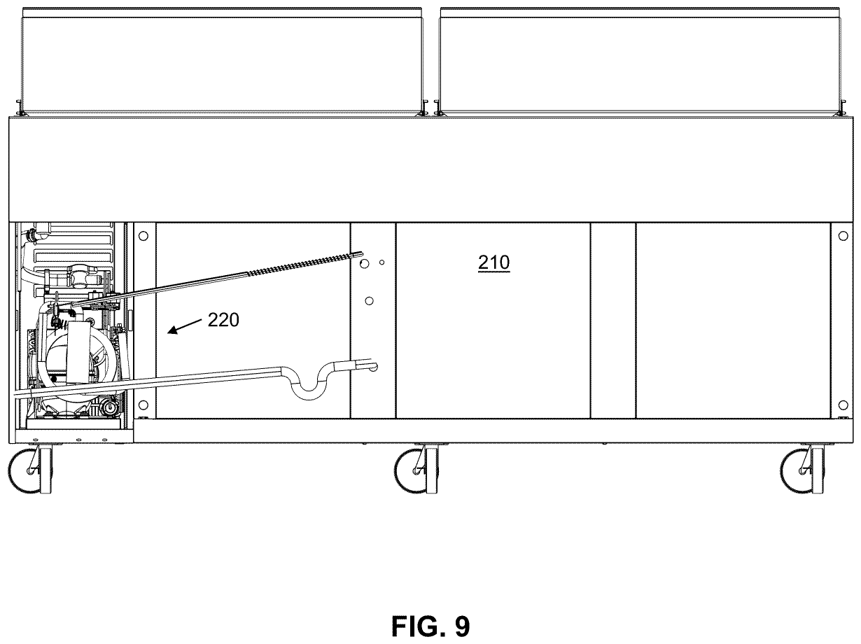

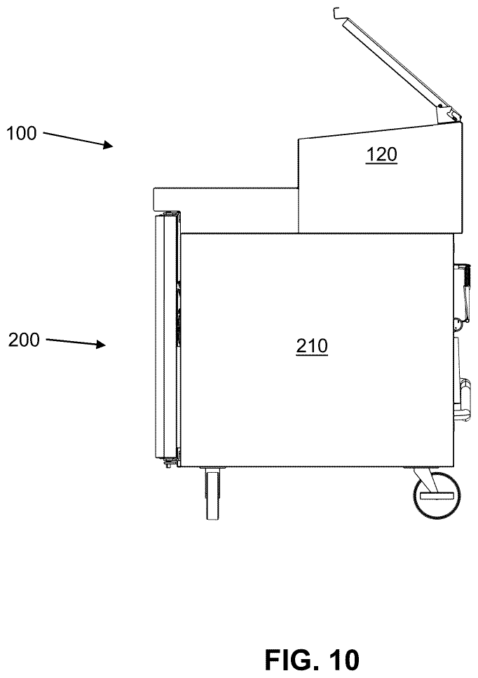

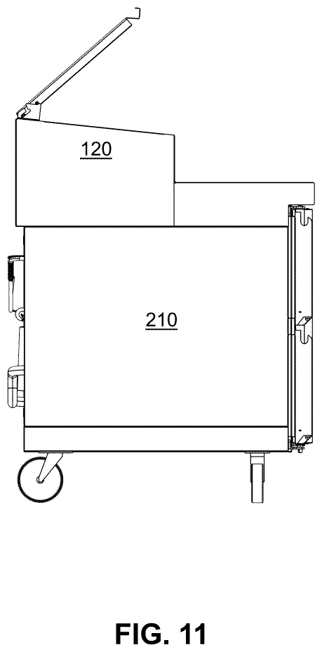

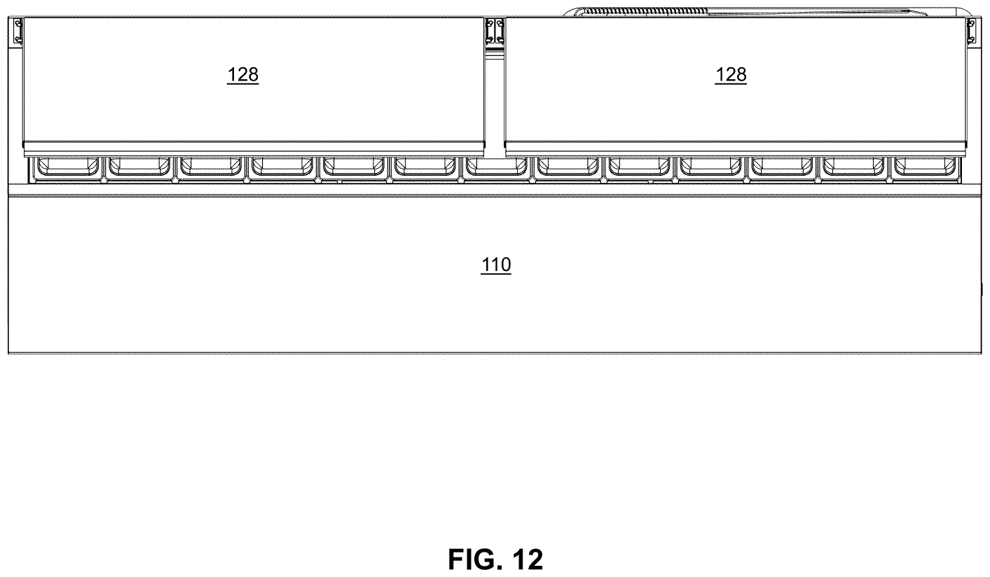

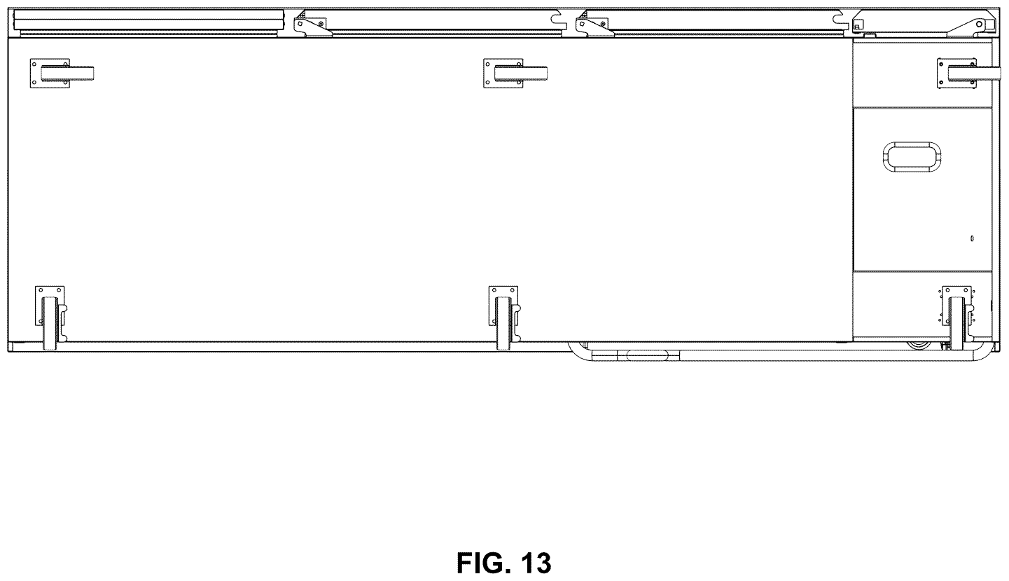

Referring to the drawings in more detail, FIGS. 1-6 show an exemplary embodiment of a food preparation system 10 of the present invention. FIGS. 7-13 show another exemplary embodiment of a food preparation system 10 of the present invention.

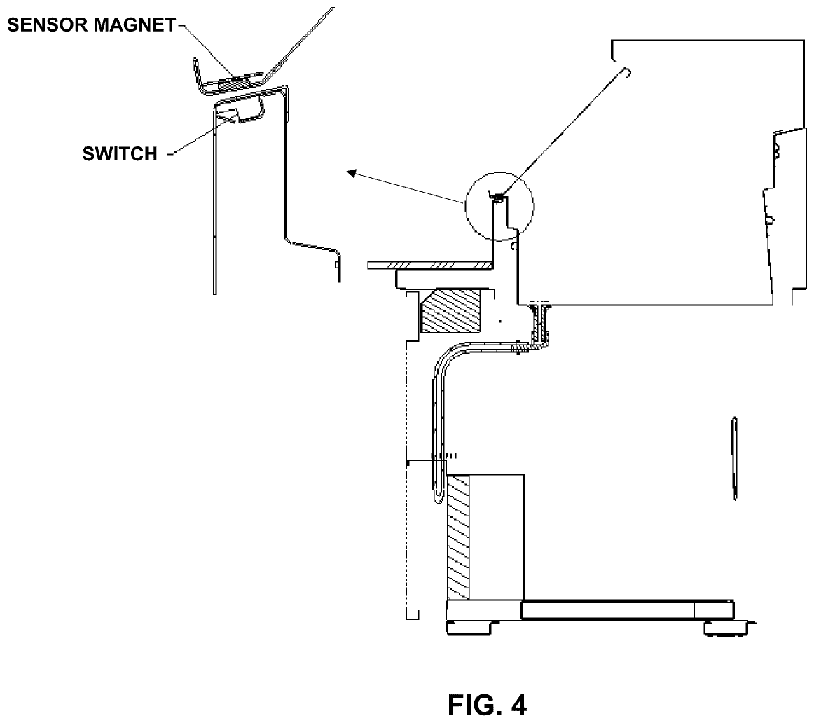

As shown in FIGS. 4-7, in exemplary embodiments of the present invention, a food preparation station 100 defines a top food housing cavity 122 and rail 124 configured to mount a plurality of food compartments or bins 126 configured to receive and house various food items for use in the food preparation and service process. In an exemplary embodiment, the top food housing cavity further includes an integrated access and enclosure lid 128 which is capable of being selectively opened and closed by a user of the system. In some embodiments, the cavity access and enclosure lid 128 of the present invention includes or is adjacently connected to a magnetic closure apparatus 132 comprising magnets configured for magnetic interaction to hold the access/enclosure lid 128 in the closed configuration, as illustrated in FIGS. 1, 4, 5, and 6. In other embodiments, the access/enclosure lid 128 includes a clasp or any other means of closure of the food housing cavity. In an exemplary embodiment, the access/enclosure lid 128 further includes an airtight seal for enclosing the food housing cavity in the closed configuration. In some embodiments, the lid 128 is split into multiple sections.

In an exemplary embodiment, the top food housing cavity is customizable such that bins 126 are capable of being arranged as desired for a user of the food preparation system. In an embodiment, the food housing cavity includes modifiable hardware such as mounting extension pieces and rails configured to engage with food item bins, which in some embodiments are, and in other embodiments are not movable, to accommodate a desired setup of the food items within the food housing cavity.

In exemplary embodiments, a base unit 200 of the present invention mounts the food preparation station 100 of the present invention. In embodiments, the base unit 200 mounts the food preparation station 100, including a work surface 110 and a food storage section 120, at a height which is convenient for food preparation by most food preparers. In some embodiments, the food preparation system 10 of the present invention is height adjustable.

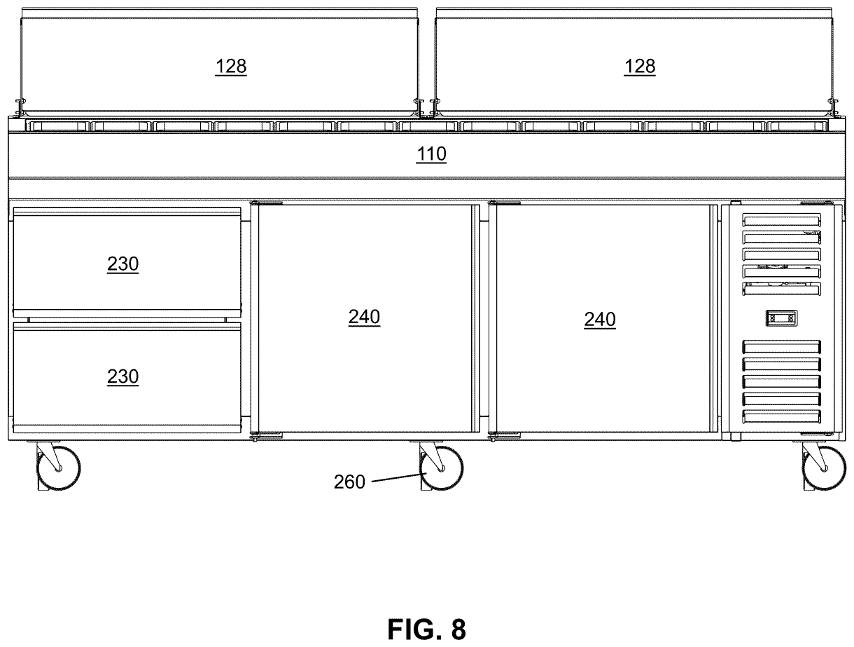

In exemplary embodiments, the base unit 200 of the present invention comprises a base cabinet 210, as shown in FIGS. 1-13. In an exemplary embodiment, the base cabinet 210 of the food preparation system 10 includes one or more drawers 230, as shown in FIG. 1. In an exemplary embodiment, drawers 230 of a base cabinet 210 provide additional storage for food items and/or food preparation and/or service accessories such as utensils, cookware, dishware, food packaging materials, etc. In some embodiments, drawers 230 of the base cabinet further comprise one or more food warmer drawers, one or more freezer drawers, and/or one or more cooler drawers. In an exemplary embodiment, a base cabinet of the present invention further comprises a housing for a cooling system 220 configured to cool the contents of the food storage section 120 to assist with maintaining safe food temperatures. In other embodiments, the base cabinet 210 includes cabinet sections 240 with one or more hinged doors in place of or in addition to drawers, as shown in FIGS. 7-8. In further embodiments, the base unit 200 does not include any drawers or cabinet sections.

In exemplary embodiments, a cooling system 220 is provided as a component of the food preparation system 10. In an exemplary embodiment, a cooling system 220 of the present invention comprises a refrigerant or coolant, such as but not limited to freon (R-22), R-134a, R-410A, R-454B, R-32a, or natural refrigerant(s); a compressor; a condenser; evaporator coils; and a fan. In some embodiments, the cooling system 220 is further configured to release heat from the system through one or more openings in the base cabinet. In some embodiments, the cooling system further integrates ductwork to supply cool air to the food housing cavity at one or more positions within the food housing cavity. In some embodiments, the cooling system further includes an expansion device.

In an exemplary embodiment of the present invention, the cooling system 220 comprises a wrapped wall cooling system for the food housing cavity. In an exemplary embodiment, at least a bottom wall of the food storage section 120 is wrapped with cooling elements, such as but not limited to copper coils, connected to the cooling system compressor and condenser and through which refrigerant is circulated. In further embodiments, portions or all of the side walls of the food storage section are also wrapped with cooling elements. In an exemplary embodiment, the wrapped wall cooling system for cooling the food storage section is a self-contained refrigeration system which provides consistent and even cooling throughout the food storage section by cycling refrigerant through the cooling elements to help maintain a uniform temperature to ensure food housed within remains at a safe and consistent temperature.

In an embodiment, refrigerant is pumped into an evaporator coil wrapped around one or more walls of the food storage section. The evaporator coil absorbs heat from the food storage section, and liquid refrigerant within the evaporation coil converts into gas. Refrigerant in a gaseous state is discharged from the evaporator coil into condenser coils. The compressor applies pressure to the refrigerant, returning the refrigerant to a liquid state, while an exhaust fan blows air onto the condenser coils toward an opening in the base cabinet, releasing heat. Liquid refrigerant is pumped back into the wrapped wall evaporator coil, and the process resets.

In an exemplary embodiment, one or more drawers or compartments of the base cabinet of the food preparation system also include wrapped wall cooling with cooling elements wrapped around one or more walls of the drawer(s) or compartment(s).

In additional embodiments, a cooling system of the present invention includes a compressor, one or more utility lines, and a fan unit. In these embodiments, the fan unit is connected by one or more utility lines to the compressor, thereby facilitating the flow of cooling liquid to ensure that any air passing through the fan unit is cooled in order to maintain a temperature of the top food storage section. In some embodiments, to ensure maximum airflow within the food storage section, one or more ducting is provided. In some embodiments, ducting is sized so as to be associated with one or more compartments within the food housing cavity. In some embodiments, ducting includes one or more perforation or aperture enabling flow of air downwards through the ducting while still directing the airflow generally such that the air when passing through the ducting is provided to the entirety of a compartment associated with the ducting. In some embodiments, the flow of air is such that air is drawn from a lower portion of the food storage section into the fan unit, where it is cooled by way of one or more radiator or cooling apparatus and drawn upward toward the ducting. The fan unit then pushes the air outward through the ducting where cool air is dissipated evenly within one or more compartments within the food housing cavity. The air is then circulated downward through the cavity and drawn back toward the fan unit where the cycle repeats. Such configuration enables selective cooling within the food storage section. In an exemplary embodiment, the food preparation system is configurable such that ducting is capable of being selectively blocked and thus the airflow to one or more compartments and/or food bins within the food housing cavity is prevented. In some embodiments, branches of ductwork lead directly to individual food storage compartments.

In an embodiment, both the food storage section 120 and food storage portion(s) of the base cabinet 210 are configured with wrapped wall cooling. In another embodiment, the food storage section is configured with wrapped wall cooling, and food storage portion(s) of the base cabinet are configured with forced air cooling. In a further embodiment, both the food storage section and food storage portion(s) of the base cabinet are configured with forced air cooling. In some embodiments, the cooling system for the food storage section and food storage portion(s) of the base cabinet share a compressor and condenser. In other embodiments, the food preparation system includes one or more separate cooling systems for the food storage section and food storage portion(s) of the base cabinet, each with its own compressor(s) and condenser(s).

In another embodiment, the cooling system of the present invention comprises a heat pump system. In further embodiments, any other type of cooling system now known or later developed is capable of being integrated into the present food preparation system without diverting from the inventive concept of the present invention.

The cooling system 220 of the present invention is configured for connection to a power source. In an exemplary embodiment, a user-operated switch on the outside of the food preparation system turns the cooling system on and off. In other embodiments, a user-operated, on/off switch or button is positioned elsewhere on or in relation to the food preparation system.

In an exemplary embodiment of the present invention, the cooling system 220 is further electrically connected to a controller and system processor configured to control parameters of the cooling system. In some embodiments, the system further includes a display and user interface and/or user knobs and/or switches configured for adjusting settings of the cooling system of the present invention.

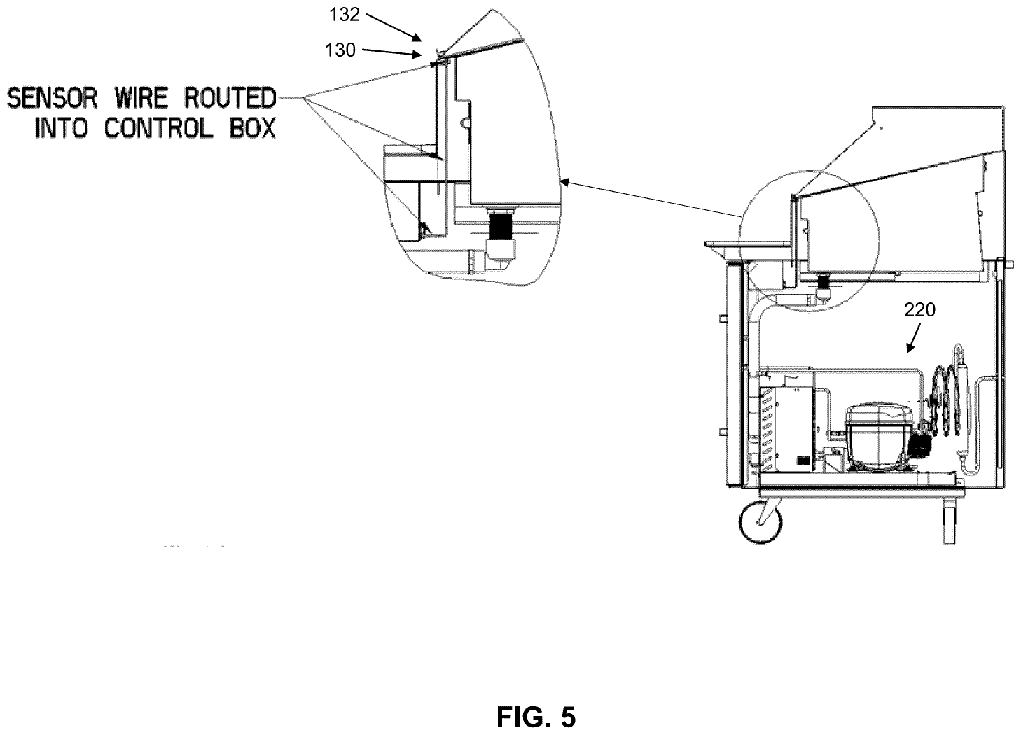

In an exemplary embodiment, the system processor is configured with a first setting of the cooling system 220 for when the food storage section is in an open configuration, with the access lid 128 open, and a second setting of the cooling system for when the food storage section is in a closed configuration, with the access lid 128 closed. In an exemplary embodiment, the food preparation system further comprises one or more sensors 130 configured to detect whether the food storage section 120 is open or closed. In an exemplary embodiment, as shown in FIGS. 4-5, such food storage section open/close sensor(s) 130 is electrically connected to a switch 150 which is electrically connected to the controller for switching between the first, open setting and the second, closed setting of the cooling system 220 when the food storage section is open or closed.

In an embodiment, the open/close sensor 130 comprises a magnetic sensor which detects when one or more magnet 132 of the access and enclosure lid 128 interacts with another magnet of the system putting the food storage section 120 in the closed configuration. Alternatively, or in addition to a magnetic sensor, embodiments of the food preparation system of the present invention incorporate one or more optical sensor for detecting whether the access and enclosure lid is closed. In additional embodiments, alternatively or in addition to other sensor(s), the food preparation system further comprises one or more thermometers, or temperature sensors, within the food storage section. In such embodiments, the food preparation system is configured to switch from the first setting of the cooling system 220 to the second setting when the temperature in the food storage section goes below a certain temperature threshold (i.e., a temperature which could cause freezing of food items) and to switch from the second setting of the cooling system to the first setting when the temperature goes above a certain temperature threshold (i.e., a temperature which could cause spoliation of food items). Embodiments of temperature sensors of the present invention include sensors configured to detect temperature of the wall(s) of the food storage section and/or other compartments of the food preparation system; sensors configured to detect the temperature of the air within the food storage section, individual food item bins, and/or other compartments of the food preparation system; and/or sensors configured to detect temperature of food items within the food housing cavity. Embodiments include contact temperature sensors, such as temperature probes, and/or contactless temperature sensors utilizing infrared technology to measure surface temperature remotely, such as fiber optic sensors, radiation thermometers, optical pyrometers, and thermal imagers. Embodiments of temperature sensors of the present invention further include but are not limited to resistance temperature detectors (RTDs), thermistors, thermocouples, and semiconductor-based sensors.

In further embodiments, the food preparation system 10 includes a user-operated switch configured to allow a user to manually switch between the first and second settings of the cooling system. In other embodiments, the food preparation system 10 includes both a sensor-connected, automatic switch and a manual, user-operated switch to toggle between the first and second settings of the cooling system. In some embodiments with both a manual switch and open/close sensor(s) and/or temperature sensor(s), the system includes a manual override option for setting the temperature of the cooling system.

In embodiments, the first and/or second setting of the cooling system is capable of being adjusted as needed to account for the ambient air temperature, housed food ingredient(s) considerations, and/or other use factors. In further embodiments, the cooling system is configured with any number of additional temperature settings as desired for different sections or compartments of the food housing cavity. In some embodiments, cooling system ductwork is configured so as to allow different temperature control in different food item bins or compartments in the food housing cavity. In some embodiments, the food preparation system comprises multiple cooling systems to allow for efficient temperature control of multiple compartments or sections of the food preparation system at different temperatures simultaneously.

In embodiments, the food preparation system of the present invention further includes a work surface or table 110 adjacent to or otherwise positioned near the food housing cavity 122. Such work surface or table 110 accommodates efficient combination of ingredients during the food preparation and service process.

In some embodiments, the food preparation system 10 further comprises a clear glass, plexiglass, or other transparent partition to allow customers and/or users to visualize what food items are housed in the food storage section 120.

In embodiments, the present food preparation system further incorporates additional sensor(s) to help detect food spoliation within the food housing cavity, such as but not limited to gas detection sensors.

In embodiments, the food preparation system further includes caster wheels 260, as shown in FIGS. 1-3, 5-11, and 13, or other type(s) of wheels for easy transport of the food preparation station. In other embodiments, the food preparation system does not include wheels and is configured for stationary, fixed installation. In further embodiments, the food preparation system is modular so as to provide additional customization options.

The present food preparation system 10 accommodates efficient preparation, storage, and usage of food item ingredients at safe temperatures. The present invention further allows for storage of food items for an extended period of time, including but not limited to overnight storage, at safe temperatures without unwanted freezing of food items by incorporating sensors 130, a switch 150, and a controller for switching cooling system settings between an open food storage section setpoint and a closed food storage section setpoint. Such systems help cutdown on break down time and/or food waste by allowing food service providers to hold prepped ingredients safely for the next day without having to move the ingredients into another cooler or freezer.

Certain terminology is used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology shall include the words specifically mentioned, derivatives thereof, and words of similar meaning.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

As used in this specification and the appended claims, the use of the term “about” means a range of values including and within 15% above and below the named value, except for nominal temperature. For example, the phrase “about 3 mM” means within 15% of 3 mM, or 2.55-3.45, inclusive. Likewise, the phrase “about 3 millimeters (mm)” means 2.55 mm-3.45 mm, inclusive. When temperature is used to denote change, the term “about” means a range of values including and within 15% above and below the named value. For example, “about 5° C.,” when used to denote a change such as in “a thermal resolution of better than 5° C. across 3 mm,” means within 15% of 5° C., or 4.25° C.-5.75° C. When referring to nominal temperature, such as “about −50° C. to about +50° C.,” the term “about” means ±5° C. Thus, for example, the phrase “about 37° C.” means 32° C-42° C.

Unless defined otherwise, all technical and scientific terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

It is also to be understood that the following claims are intended to cover all of the generic and specific features of the invention herein described, and all statements of the scope of the invention which, as a matter of language, might be said to fall therebetween.

1. A food preparation system comprising:
a base unit;
a food preparation station mounted on said base unit and comprising a food storage section configured for housing one or more food ingredients;
wherein said food storage section comprises an access lid allowing for selective movement between an open configuration and a closed configuration of said food storage section;
a cooling system configured to cool said food storage section; and
a switch electrically connected to said cooling system and to a controller configured for switching between a first setting and a second setting of said cooling system;
wherein said first setting is configured for cooling said food storage section to a first temperature for when said food storage section is in said open configuration, and said second setting is configured for cooling said food storage section to a second temperature for when said food storage section is in said closed configuration.

2. The system of claim 1, further comprising:
a sensor electrically connected to said switch and configured for detection of when said food storage section is in said open configuration or said closed configuration; and
wherein said system is configured for automatically switching between said first setting and said second setting of said cooling system based on said detection of said sensor.

3. The system of claim 2, wherein:
said access lid comprises a magnetic closure apparatus configured for selective magnetic interaction to hold said access lid closed in said closed configuration of said food storage section; and
said sensor comprises a magnetic sensor.

4. The system of claim 2, wherein:
said sensor comprises a temperature sensor configured for detection of an air temperature of said food storage section.

5. The system of claim 2, wherein:
said sensor comprises an optical sensor configured to detect whether said access lid is closed.

6. The system of claim 1, wherein:
said switch comprises a manual switch for operation by a user.

7. The system of claim 1, wherein:
said food preparation station further comprises a work surface.

8. The system of claim 1, wherein:
said cooling system comprises a wrapped wall cooling system.

9. The system of claim 1, wherein:
said cooling system comprises a forced air cooling system.

10. The system of claim 1, wherein:
said food storage section defines a cavity and comprises a rail positioned through said cavity, said rail configured to selectively mount one or more food storage compartments within said cavity.

11. The system of claim 1, wherein:
said base unit comprises a base cabinet.

12. The system of claim 11, wherein:
said base cabinet comprises one or more drawers; and
each said drawer is configured to provide a heated storage area or a cooled storage area.

13. The system of claim 1, wherein:
said system is configured to allow adjustment of said first temperature of said first setting and said second temperature of said second setting of said cooling system.

14. A food preparation method comprising:
providing a food preparation system comprising a base unit, a food preparation station mounted on said base unit and comprising a food storage section, wherein said food storage section comprises an access lid allowing for selective movement between an open configuration and a closed configuration, a cooling system configured to cool said food storage section, and a switch electrically connected to said cooling system and to a controller configured for switching between a first setting and a second setting of said cooling system;
placing one or more food ingredients within said food storage section;
opening said access lid to place said food storage section in said open configuration;
switching said cooling system to said first setting and cooling said food storage section to a first temperature with said food storage section in said open configuration;
closing said access lid to place said food storage section in said closed configuration; and
switching said cooling system to said second setting and cooling said food storage section to a second temperature with said food storage section in said closed configuration.

15. The method of claim 14, wherein said second temperature comprises a temperature safe for extended storage of said one or more food ingredients, the method further comprising:
storing said one or more food ingredients for an extended period of time with said food storage section in said closed configuration.

16. The method of claim 15, wherein:
said extended period of time comprises overnight.

17. The method of claim 15, wherein:
said temperature safe for extended storage of said one or more food ingredients is further a temperature configured to avoid freezing of said one or more food ingredients over said extended period of time.

18. The method of claim 14, wherein said food preparation system further comprises a sensor electrically connected to said switch and configured for detection of when said food storage section is in said open configuration or said closed configuration, the method further comprising:
automatically switching between said first setting and said second setting of said cooling system based on said detection of said sensor.

19. The method of claim 18, wherein:
said sensor is one selected from the group consisting of a magnetic sensor, a temperature sensor, an optical sensor, and combinations thereof.

20. The method of claim 14, wherein said base unit comprises a base cabinet comprising a cooled storage drawer, the method further comprising:
placing one or more additional food ingredients in said cooled storage drawer.
